(19) United States
(12) Patent Application Publication
(10) Pub. No.: US 2021/0383434 A1
(43) Pub. Date: Dec. 9, 2021

(54) METHOD AND SYSTEM FOR FACILITATING MARKETING AND SALES OF PRODUCTS BY PRODUCT SUPPLIERS

(71) Applicant: OSAMA SULAIMAN ALSALLOUM, DAMMAM (SA)

(72) Inventor: OSAMA SULAIMAN ALSALLOUM, DAMMAM (SA)

(21) Appl. No.: 17/408,425

(22) Filed: Aug. 22, 2021

(51) Int. Cl. G06Q 30/02; G06Q 10/08; G06Q 20/18; G06Q 30/06

(52) U.S. Cl. CPC G06Q 30/0268; G06Q 30/0633; G06Q 20/18; G06Q 10/087

(57) ABSTRACT

The embodiments herein provide a method and system for facilitating marketing and sales of products by product suppliers. The method includes displaying the product to be marketed at a kiosk located at a public or private premise. Further, the method includes capturing, at the kiosk, a first set of data through a customer dashboard presented on a customer console. Further, the method includes capturing, a second set of data through one or more sensor means configured at the kiosk. Further, the method includes receiving, at a supplier dashboard, the first set of data and the second set of data for performing product inventory, and customer related analytics, the supplier dashboard is accessible and manageable by the product supplier subscribed to the kiosk's service from a kiosk service provider. Further, the method includes managing product inventory and product related information, based on the performed product inventory and customer related analytics.

### TECHNICAL FIELD

The present invention relates generally to a retail kiosk, and more particularly, to a method and system for facilitating marketing and sales of products by product suppliers though retail kiosks.

### BACKGROUND

Retail stores are growing day by day. When entering a retail store, customers must often do a comparison between their current products and the products they are looking for that are offered by the retailer. This work involves the customers identifying the products and checking the features of the products. Then, decide which are appropriate for them. Retailers have tried to improvise the product selection process by integrating information on a customer's previous interactions with the products and purchase decision on the products in the retail store, general customer data, and contract details of the customers to help the customer make better decisions and select a product or service.

However, due to competitive cost pressures, retailers are forced to increase operational efficiencies and cut costs. Due to these pricing pressures, retailers often have a difficult time providing quality product information and sales support in their stores. Additionally, retailers lack identifying their prime customers when they walk in the door and no way to connect the customers to any intermediary services for an improved shopping experience. The poor shopping experience can reduce customer spending, create an impaired customer experience, raise product dissatisfaction, and motivate customer defection.

Attempts have been made to provide limited solutions to some of the above issues by substituting store personnel with kiosks. Kiosks located in retail stores have also been created to provide general product information and sales help. However, these facilities have generally failed because the retail store kiosks are not well designed. Often, these kiosks are placed in poor locations to avoid interruption of traffic patterns in key locations in the retail store. Every now and then the retail store kiosks are underutilized to meet current customer demand.

Although kiosks are proposed in the past, they have their own shortcomings or limitations, thus there still exist a need for a more reliable solution. Accordingly, proposed is a method and system for facilitating marketing and sales of products by product suppliers though the retail kiosks.

### SUMMARY

It will be understood that this disclosure in not limited to the particular systems, and methodologies described, as there can be multiple possible embodiments of the present disclosure which are not expressly illustrated in the present disclosure. It is also to be understood that the terminology used in the description is for the purpose of describing the particular versions or embodiments only, and is not intended to limit the scope of the present disclosure.

It is an objective of the present invention to facilitates marketing and sales of a product by a product supplier.

It is another objective of the present invention to provide customer dashboard that enables the customer to navigate through the product specifications, and place purchase order.

It is another objective of the present invention to receive the first set of data and the second set of data for performing product inventory, and customer related analytics.

It is another objective of the present invention to facilitate managing product inventory and product related information displayed at a kiosk by the product supplier from a remote location.

In an embodiment, the present invention provides system and method for facilitating marketing and sales of the product by the product supplier. The method includes displaying the product to be marketed at a kiosk located at a public or private premise. Furthermore, the method includes capturing, at the kiosk, a first set of data through a customer dashboard presented on a customer console. Furthermore, the method includes capturing, a second set of data through one or more sensor means configured at the kiosk. Furthermore, the method includes receiving, at a supplier dashboard, the first set of data and the second set of data for performing product inventory, and customer related analytics, the supplier dashboard is accessible and manageable by the product supplier subscribed to a server related to a kiosk service provider. Furthermore, the method includes managing product inventory and product related information displayed at the kiosk, based on the performed product inventory and customer related analytics.

In an embodiment, the customer console includes at least a touch panel, a tablet, a phone and the like.

In an embodiment, the first set of data comprises customer information, brand information, purchase order information, ratings provided on product, and feedback provided on product.

In an embodiment, the one or more sensor means comprises one or more cameras.

In an embodiment, the one or more sensor means comprises at least a motion sensor, gesture sensor, a proximity sensor.

In an embodiment, the second set of data includes live video stream of customers, live video steam of surroundings, recorded historical videos of the customers, recorded historical videos of surrounding, and customer gesture information captured by the one or more sensor means.

In an embodiment, the method of providing accessibility of the supplier dashboard to the product supplier by the kiosk service provider includes receiving subscription request from the product supplier, receiving payment proof of the subscription from the product supplier, allocating a supplier identity (SID) to the product supplier, and providing login details of the supplier dashboard to the product supplier.

In an embodiment, a notification to the customer is sent by the kiosk service provider server, if any changes to the purchase order of the customer occurs.

In an embodiment, a notification to product supplier is sent by the kiosk service provider server, if any update to the supplier dashboard is available.

In an embodiment, the customer related analytics includes customer behaviour tracking with respect to the product displayed at the kiosk.

In an embodiment, the method of managing product inventory and product related information displayed at the kiosk includes updating product specification, updating brand specific information, customising user interface elements displayed at the customer console, updating existing offers on the product being displayed to the customer.

In an embodiment, the kiosk includes a product display platform for displaying the product, a display screen for displaying the product related information, the customer console for presenting the customer dashboard that enables the customer to navigate through the product specifications, and place purchase order, and the one or more sensor means for capturing the second set of data.

These and other features and advantages of the present invention will become apparent from the detailed description below, in light of the accompanying drawings.

### BRIEF DESCRIPTION OF THE DRAWINGS

FIG. 1 illustrates a computing environment or general implementation of a system for facilitating marketing and sales of a product by a product supplier, according to an exemplary embodiment of the present invention;

FIG. 2 illustrates a front view of an exemplary kiosk for facilitating marketing and sales of the product by the product supplier, according to an embodiment of the present invention;

FIG. 3 is a schematic diagram illustrating elements of the system that facilitates in marketing and sales of the product by the product supplier, according to an exemplary embodiment of the present invention;

FIG. 4 illustrates a user interface of a customer dashboard, according to an exemplary embodiment of the present invention;

FIG. 5 illustrates a user interface of a supplier dashboard, according to an exemplary embodiment of the present invention;

FIG. 6 illustrates a user interface of notification and order details, according to an exemplary embodiment of the present invention;

FIG. 7 illustrates a method for providing accessibility of the supplier dashboard to the product supplier by a kiosk service provider, according to an exemplary embodiment of the present invention; and

FIG. 8 illustrates a method for facilitating marketing and sales of the product by the product supplier, according to an exemplary embodiment of the present invention.

### DETAILED DESCRIPTION

As used in the specification, the singular forms “a”, “an” and “the” may also include plural references. For example, the term “an article” may include a plurality of articles. Those with ordinary skill in the art will appreciate that the elements in the figures are illustrated for simplicity and clarity and are not necessarily drawn to scale. There may be additional components or processes described in the foregoing application that are not depicted on the described drawings. In the event such a component or process is described, but not depicted in a drawing, the absence of such component and process from the drawings should not be considered as an omission of such design from the specification.

Before describing the present invention in detail, it should be observed that the present invention utilizes a combination of components or processes, which constitutes a system and method for facilitating marketing and sales of a product by a product supplier. Accordingly, the components or processes have been represented, showing only specific details that are pertinent for an understanding of the present invention so as not to obscure the disclosure with details that will be readily apparent to those with ordinary skill in the art having the benefit of the description herein. As required, detailed embodiments of the present invention are disclosed herein; however, it is to be understood that the disclosed embodiments are merely exemplary of the invention, which can be embodied in various forms. Therefore, specific component level details and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

References to “one embodiment”, “an embodiment”, “another embodiment”, “one example”, “an example”, “another example”, “yet another example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment. The words “comprising”, “having”, “containing”, and “including”, and other forms thereof, are intended to be equivalent in meaning and be open ended in that an item or items following any one of these words is not meant to be an exhaustive listing of such item or items or meant to be limited to only the listed item or items.

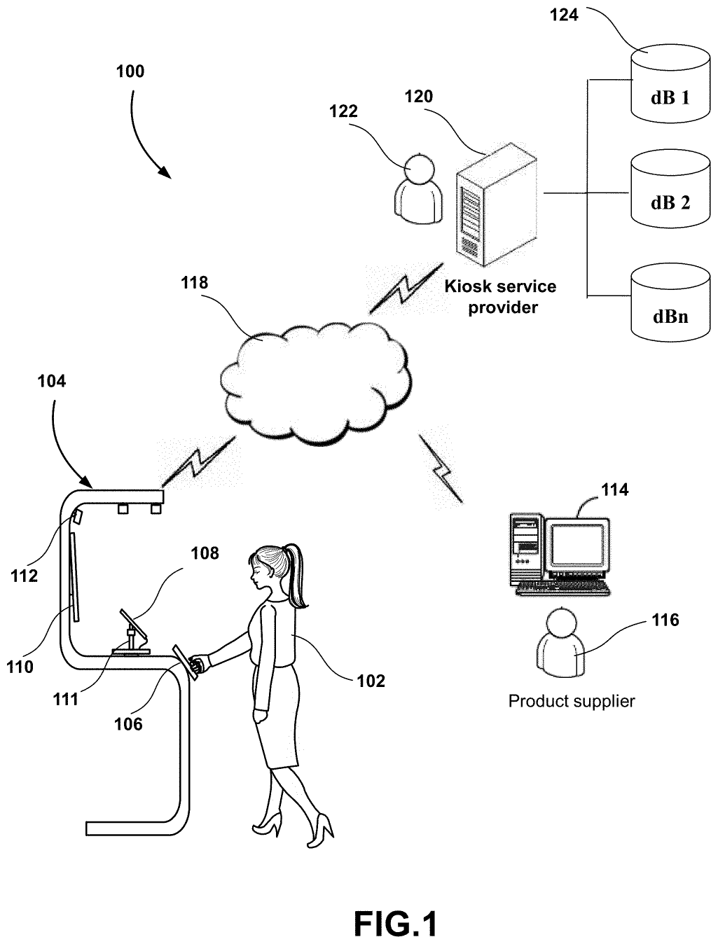

The system and method for facilitating marketing and sales of a product by a product supplier will now be described with reference to the accompanying drawings, particularly FIGS. 1-8.

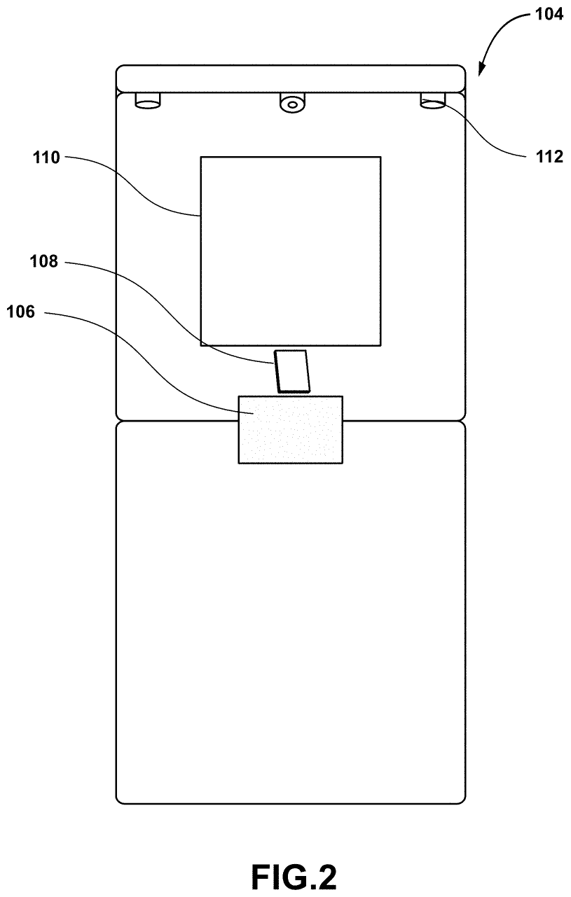

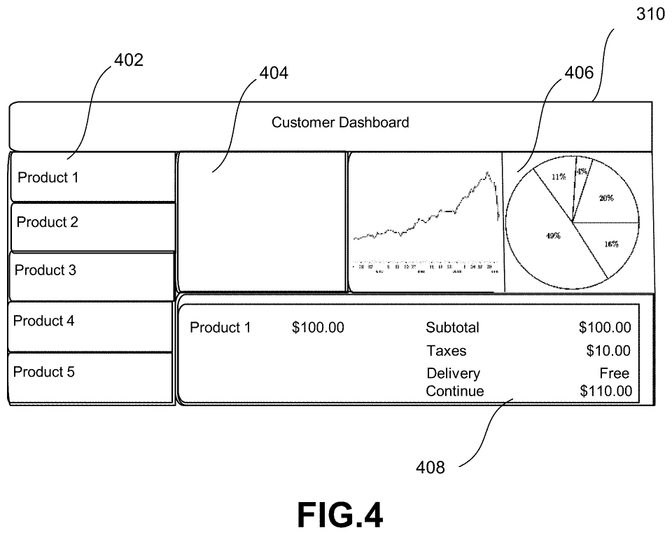

Referring to FIG. 1 in conjunction with FIGS. 2-6, a system 100 facilitating marketing and sales of a product 108 by a product supplier 116 through a kiosk 104 is shown, in accordance with an exemplary embodiment of the present invention. The system 100 includes a customer 102 who interacts with the kiosk 104 preferably located at public premises such as super markets or private premise. The product 108 as shown in the FIGS. 1 and 2 is a mobile phone but it can be any other products such as for example coffee machine, hair dryer, and so on. A front view of an exemplary kiosk 104 is disclosed in conjunction with FIG. 2. The customer 102 is a recipient of a good, service, product, or an idea obtained from the supplier 116 via a financial transaction. The kiosk 104 includes a customer console 106 configured to present a customer dashboard 310, as shown in FIG. 4. In an embodiment, the customer console 106 includes at least a touch panel, a tablet, a computer, a phone. The customer console 106 is configured to capture a first set of data through a customer dashboard 310 and share the first set of data with the product supplier 116. In an embodiment, the first set of data includes, but not limited to customer information, brand information, purchase order information, ratings provided on the product, and feedback provided on the product.

The customer information includes, but are not limited to first name, last name, location details, physical address, zip code, age, contact number, email address, and the like. The brand information includes, but are not limited to brand name, order volume of the brand, click through rate (CTR) of the brand, and the like. The purchase order information includes, but are not limited to name of the product, quantity of the product to be purchased, delivery address, amount spent on purchase, and the like.

Further, the kiosk 104 includes one or more sensor means configured to capture a second set of data. In an embodiment, the second set of data includes but not limited to live video stream of customers, live video steam of surroundings, recorded historical videos of the customers, recorded historical videos of surrounding, and customer gesture information captured by the one or more sensor means. In an embodiment, the one or more sensor means includes one or more cameras for capturing the live video stream of customers, and the live video steam of surroundings. In another embodiment, the one or more sensor means includes at least a motion sensor, gesture sensor, a proximity sensor or any other sensors for capturing customer gesture information, proximity information, time spent near the kiosk and so on. The second set of data is shared with the product supplier 116.

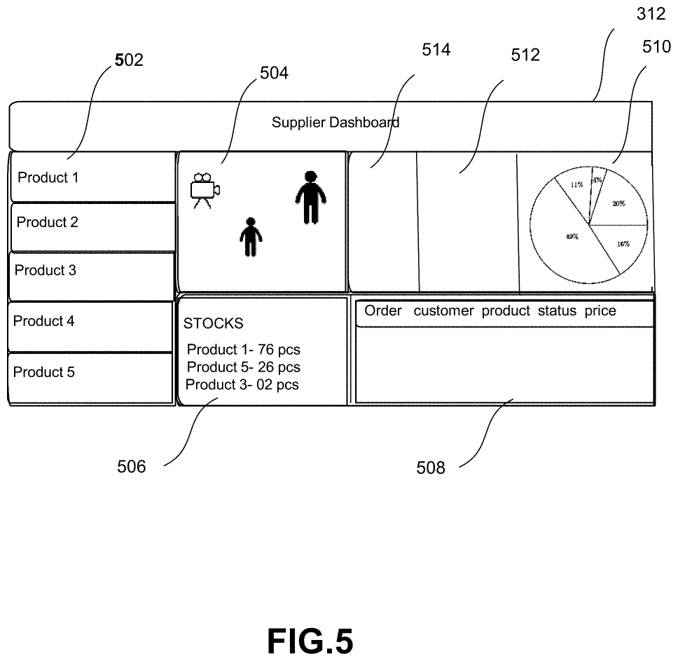

Further, the system includes a computing device 114 configured to display a supplier dashboard 312, as shown in FIG. 5. The supplier dashboard 312 is accessed by the product supplier 116 after authentication. For authentication, the product supplier 116 provides valid login credentials on login interface displayed on the supplier dashboard 312. In an embodiment, two-way authentication is used to access the supplier dashboard 312. Examples of the authentication mechanism includes, but are not limited to biometric authentication, retina scanning, face scanning, username and password and the like.

In context of the present invention, the computing device 114 refers to an electronic device that can be used to communicate over the communication network 118. Examples of the computing device 114 include, but are not limited to a cell phone, a smart phone, a personal digital assistant (PDA), a personal computer, a cloud enabled device, a laptop, and a tablet computer. Examples of types of the communication network 118 include, but are not limited to a local area network, a wide area network, a radio network, a virtual private network, an internet area network, a metropolitan area network, a satellite network, Wi-Fi, Bluetooth Low energy, a wireless network, and a telecommunication network. Examples of the telecommunication network include, but are not limited to a global system for mobile communication (GSM) network, a general packet radio service (GPRS) network, third Generation Partnership Project (3GPP), 4G, Long-Term Evolution (LTE), an enhanced data GSM environment (EDGE) and a Universal Mobile Telecommunications System (UMTS).

In an embodiment, the supplier dashboard 312 is configured to receive the first set of data and the second set of data for performing product inventory, and customer related analytics. The supplier dashboard 312 is accessible and manageable by the product supplier 116 subscribed to the kiosk's service from a kiosk service provider 122 upon registering with a kiosk service provider server 120.

The kiosk service provider 122 receives a subscription request from the product supplier 116. In an embodiment, an email is used as a medium of communication of the subscription request, however, it is not limited to only email. Other mediums such as online subscription though a website of the kiosk service provider 122, Short Message Service (SMS), instant chat message can be used for sending the subscription request. After receiving the subscription request, the kiosk service provider 122 request for a payment proof for the subscription. The product supplier 116 sends the payment proof to the kiosk service provider 122. Upon receiving the payment proof for the subscription, the kiosk service provider 122 allocates a supplier identity (SID) to the product supplier 116 through a kiosk service provider server 120. The SID is unique to the product supplier 116. In an embodiment, the kiosk service provider server 120 (hereinafter also referred as server 120) provides an environment where the supplier dashboard 312 is hosted. In an embodiment, the kiosk service provider server 120 is a cloud server.

In an embodiment, the kiosk service provider server 120 stores information, in one or more datastore 124, for example, SIDs, the first set of data, the second set of data, and data related to the product inventory, and customer related analytics. After allocating the SID, the kiosk service provider 122 provides login details of the supplier dashboard 312 to the product supplier 116. Using the login details, the product supplier 116 can access the supplier dashboard 312.

In an embodiment, an analytics engine is employed at the supplier dashboard 312 to provide real time system decisions that result from the first set of data and the second set of data. In an embodiment, the customer related analytics includes customer behaviour tracking with respect to the product 108 displayed at the kiosk 104. For the customer 102, results of the customer related analytics are provided to the kiosk 104 in the form of recommendations which can be displayed on the display panel 110 located at the kiosk 104. This improves customer experience at the kiosk 104 on the products and product related information. Examples of the display panel 110 include, but are not limited to a LED screen, a LCD screen, and a TFT screen. Further, product inventory is managed based on the analytic. For example, the product supplier 116 takes decision on adding, removing, changing the brand of the product, and maintaining the volume of the product, based on the product inventory related analytics. This enhances product supplier's control over managing the inventory at the kiosk 104. In an embodiment, managing product inventory and product related information displayed at the kiosk 104 includes updating product specification, updating brand specific information, customising user interface elements displayed at the customer console 106, updating existing offers on the product 108 being displayed to the customer 102.

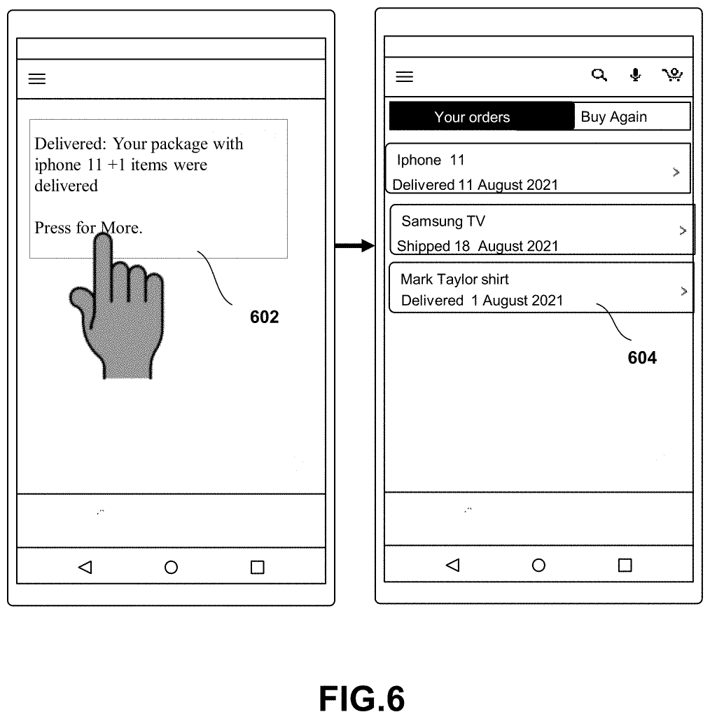

In an embodiment, the kiosk service provider server 120 employs notification service. For example, the customer 102 receives a notification, as shown in FIG. 6, if any changes to the purchase order of the customer 102 occurs. This enhances tracking of the order details and state of logistic related to the purchase order. Similarly, the product supplier 116 receives a notification from the kiosk service provider server 120, if any update to the supplier dashboard 312 is available. In an embodiment, update to the supplier dashboard 312 includes inventory parameters, subscription types, security related information, version of the supplier dashboard 312. For example, if the kiosk service provider 122 releases a new version of the supplier dashboard 312, the product supplier 116 receives the notification to update the version of the supplier dashboard 312. Thus, the product supplier 116 never misses any updates from the kiosk service provider 122.

In an example, the inventory parameters include brand names, quantity of the products, and volume of the sale. In an example, the subscription types include basic subscription, intermediate subscription, premium subscription, free subscription, recommended subscription. In another example, subscription types may include weekly subscription, monthly subscription etc. In an example, the security related information includes security patch version, and login location message.

The system 100 described above enhances the product selection process by integrating information on the customer's previous interactions with the products and purchase decision on the products at the kiosk 104 in the retail stores, general consumer data, and contract details of the customers to help the customer 102 to make better decisions and select the product 108 or service. It also helps the retailers to identify their prime customers when they walk in the door and connect the customers for providing better service. This enhances shopping experience, customer spending, customer experience at the kiosk 104, raise product satisfaction, and motivate customer loyalty.

FIG. 2 illustrates the front view of the kiosk 104 for facilitating marketing and sales of the product 102 by the product supplier 116, according to an exemplary embodiment of the present invention. As shown in FIG. 2, the kiosk 104 includes the customer console 106, the product 108 mounted on a product display platform 111 (seen in FIG. 1), the display panel 110, and the sensor means 112. In an embodiment, the customer console 106 is configured to present the customer dashboard 310, as shown in FIG. 4. In an embodiment, the customer console 106 includes at least a touch panel, a tablet, a phone. The customer 102 interacts with the customer dashboard 310 for selecting and purchasing one or more products displayed on the kiosk 104. The customer console 106 is configured to capture the first set of data through the customer dashboard 310 and share the first set of data with the product supplier 116.

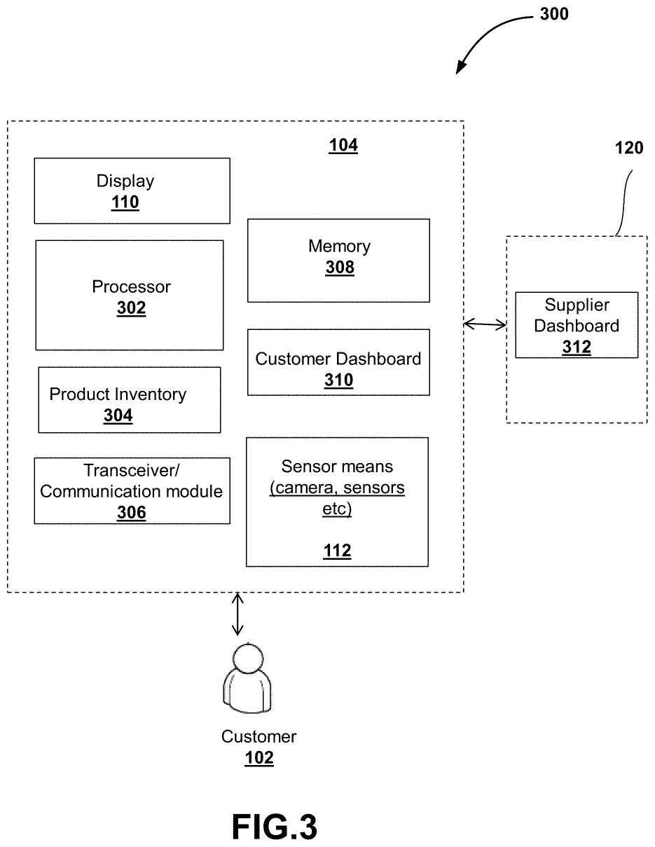

In an embodiment, the display panel 110 is configured to display product details, product specification and the results of the customer related analytics in the form of recommendations. Or the same can also be displayed on the customer console 106. In an embodiment, the sensor means 112 are configured to capture the live video stream of customers, the live video steam of surroundings, and the customer gesture information. In an embodiment, the sensor means 112 compresses the information before sharing it to the supplier dashboard 312. Details of different modules of the kiosk 104 is disclosed in conjunction with FIG. 3.

FIG. 3 is a schematic diagram illustrating elements of the system 300 that facilitates marketing and sales of the product 108 by the product supplier 116, according to an exemplary embodiment of the present invention. As shown in FIG. 3, the customer 102 interacts with the kiosk 104 at the public premise. Examples of the public premise include, but are not limited to a retail shop, a shopping mall, a bus stop, a railway station, and an airport. In accordance with an example implementation, the kiosk 104 may include at least a processor 302, one or more memory, such as memory 308, a transceiver or communication module 306, one or more sensor means, such as sensor means 112, a display 110, a product inventory 304, and customer dashboard 310.

The processor 302 may be communicably coupled with the transceiver/communication module 306 to receive signals. Further, the transceiver module 306 may be configured to transmit signals generated by the processor 306. Furthermore, the transceiver module 306 may be configured to send the data received from the customer dashboard 310 to the supplier dashboard 312. In an embodiment, the supplier dashboard 312 is provided by the kiosk service provider server 120. The processor 302 is in communication with the memory 308 for temporary storing of data. The memory 308 may be volatile (such as RAM), non-volatile (such as ROM, flash memory, etc.), or some combination of the two. The kiosk 104 may be connected to other information processing devices by using I/O interfaces (not shown). The I/O interfaces may include a variety of software and hardware interfaces, for instance, interface for peripheral device(s) such as a keyboard, a mouse, a scanner, an external memory, a printer and the like. The display 110 may be utilized to display results of the customer related analytics in the form of recommendations, and product details. The product inventory 304 is configured to provide storage space for the products to be displayed. The product supplier 116 places one or more products on the product inventory 304 for facilitating marketing and sales of the products. The customer dashboard 310 is configured to capture the first set of data and send it to the supplier dashboard 312. The sensor means (camera, sensors, etc) are configured to capture the second set of data and send it to the supplier dashboard 312. The supplier dashboard 312 is configured to receive the first set of data and the second set of data for performing product inventory, and customer related analytics.

FIG. 4 illustrates an exemplary user interface of the customer dashboard 310, according to an embodiment of the present invention. In an example, the user interface of the customer dashboard 310 includes a products name section 402, a product specification section 404, a graph display section 406, and a purchase order section 408. The products name section 402 is configured to display name of one or more products that are placed on the kiosk 104. The names are displayed with different colours. When the customer 102 clicks one of the products, the related product description is displayed on the product specification section 404. In an example, a graph display section 406 is configured to display analytics of brand data, product sell data, customers feedback, and CTR in the form of one or more graph. In an example, the graph is a bar chart, a pie chart, and a line chart.

In an example, the purchase order section 408 is configured to allow the customer 102 to add one or more products to shopping cart. Further, the purchase order section 408 allows the customer 102 to check out and complete the order placement process. Thus providing a hassle free buying experience.

FIG. 5 illustrates a user interface of the supplier dashboard 312, according to an exemplary embodiment of the present invention. In an example, the user interface of the supplier dashboard 312 includes a products name section 502, a live feed section 504, an inventory data section 506, an order details section 508, an analytics section 510, a customer data section 512, and a product information section 514. The product related information may include pricing, details related to the product and so on. The products name section 502 is configured to display name of one or more products that are placed on the kiosk 104. The customer data section 512 is configured to receive the first set of data through the customer dashboard 310. The live feed section 504 is configured to receive the second set of data through the one or more sensor means 112. The analytics section 510 is configured to perform product inventory, and customer related analytics and display the analytics in graphs.

In an example, the order details section 508 is configured to display the purchase order details and state of the purchase order. Examples of the state of the purchase order includes open, shipped, out for delivery, delivered. The inventory data section 506 is configured to display data related to the quantity of the products in the inventory, sales volume, required quantity for the purchase order, and the like.

FIG. 6 illustrates a user interface of the notification 602 and order details, according to an exemplary embodiment of the present invention. As shown in the FIG. 6, the customer 102 receives the notification 602 related to the purchase order placed on the kiosk 104 if any changes to the purchase order of the customer 102 occurs. This notification will be generated by the server 120. For example, if the order is already delivered, the customer receives the delivered notification 602. The customer 102 can click on “Press for More” and check the order details on order details user interface 604. The order details user interface 604 displays the state of the purchase order, for example, open, shipped, out for delivery, delivered.

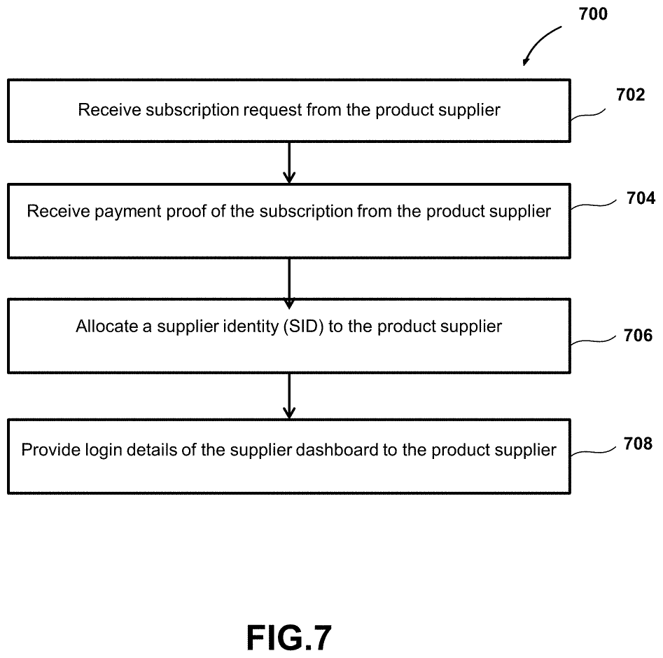

FIG. 7 illustrates a flow diagram 700 of a method for providing accessibility of the supplier dashboard 312 to the product supplier 116 by the kiosk service provider 122, according to an exemplary embodiment of the present invention. At step 702, the method includes receiving the subscription request from the product supplier 116. The method allows the kiosk service provider 122 to receive the subscription request from the product supplier 116. At step 704, the method includes receiving the payment proof of the subscription from the product supplier 116. The method allows the kiosk service provider 122 to receive the payment proof of the subscription from the product supplier 116.

At step 706, the method includes allocating the supplier identity (SID) to the product supplier 116. The method allows the kiosk service provider 122 to allocate the supplier identity (SID) to the product supplier 116. At step 708, the method includes providing the login details of the supplier dashboard 312 to the product supplier 116. The method allows the kiosk service provider 122 to provide the login details of the supplier dashboard 312 to the product supplier 116.

The various actions, acts, blocks, steps, or the like in the flow diagram may be performed in the order presented, in a different order or simultaneously. Further, in some embodiments, some of the actions, acts, blocks, steps, or the like may be omitted, added, modified, skipped, or the like without departing from the scope of the invention.

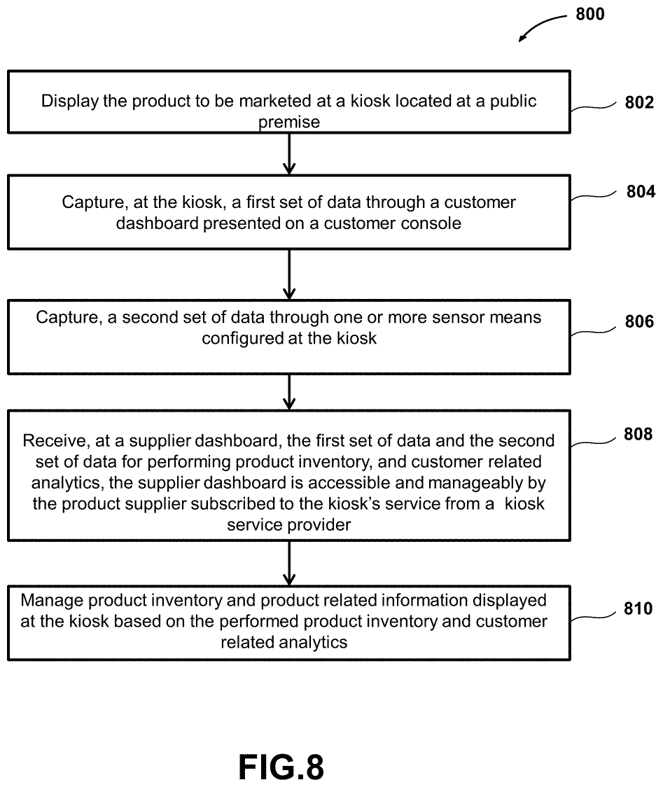

FIG. 8 illustrates a flow diagram 800 of the method for facilitating marketing and sales of the product by the product supplier, according to an exemplary embodiment of the present invention. At step 802, the method includes displaying the product 108 to be marketed at the kiosk 104 located at the public premise. The method allows the kiosk 104 to display the product 108 to be marketed at the public premise. At step 804, the method includes capturing the first set of data through the customer dashboard 310 presented on a customer console 106. The method allows the customer dashboard 310 presented on a customer console 106 to capture the first set of data.

At step 806, the method includes capturing the second set of data through the one or more sensor means 112 configured at the kiosk 104. The method allows the one or more sensor means 112 configured at the kiosk 104 to capture the second set of data. At step 808, the method includes receiving the first set of data and the second set of data for performing the product inventory, and customer related analytics. The method allows the supplier dashboard 312 to receive the first set of data and the second set of data for performing the product inventory, and customer related analytics, wherein the supplier dashboard 312 is accessible and manageable by the product supplier 116 subscribed to the kiosk's service from the kiosk service provider 122. At step 810, the method includes managing the product inventory and product related information displayed at the kiosk 104 based on the performed product inventory and customer related analytics. The method allows the kiosk 104 to manage the product inventory and product related information based on the performed product inventory and customer related analytics.

The various actions, acts, blocks, steps, or the like in the flow diagram may be performed in the order presented, in a different order or simultaneously. Further, in some embodiments, some of the actions, acts, blocks, steps, or the like may be omitted, added, modified, skipped, or the like without departing from the scope of the invention.

Although particular embodiments of the invention have been described in detail for purposes of illustration, various modifications and enhancements may be made without departing from the spirit and scope of the invention.

What is claimed is:

1. A method for facilitating marketing and sales of a product by a product supplier, the method comprising:
displaying the product to be marketed at a kiosk located at a public or private premise;
capturing, at the kiosk, a first set of data through a customer dashboard presented on a customer console;
capturing, a second set of data through one or more sensor means configured at the kiosk;
receiving, at a supplier dashboard, the first set of data and the second set of data for performing product inventory, and customer related analytics, the supplier dashboard is accessible and manageable by the product supplier subscribed to a server relate to a kiosk service provider; and
managing product inventory and product related information displayed at the kiosk, based on the performed product inventory and customer related analytics.

2. The method of claim 1, wherein the customer console comprises at least a touch panel, a tablet, a phone, a computer.

3. The method of claim 1, wherein the first set of data comprises customer information, brand information, purchase order information, ratings provided on product, and feedback provided on product.

4. The method of claim 1, wherein the one or more sensor means comprises one or more cameras.

5. The method of claim 1, wherein the one or more sensor means comprises at least a motion sensor, a gesture sensor, a proximity sensor.

6. The method of claim 1, wherein the second set of data comprises live video stream of customers, live video stream of surroundings, recorded historical videos of the customers, recorded historical videos of surrounding, and customer gesture information captured by the one or more sensor means.

7. The method of claim 1, wherein providing accessibility of the supplier dashboard to the product supplier by the kiosk service provider comprising the steps of:
receiving subscription request from the product supplier;
receiving payment proof of the subscription from the product supplier;
allocating a supplier identity (SID) to the product supplier; and
providing login details of the supplier dashboard to the product supplier.

8. The method of claim 1, further comprising sending, by the server, a notification to the customer if any changes to the purchase order of the customer occurs.

9. The method of claim 1, further comprising sending, by the server a notification to the product supplier if any update to the supplier dashboard is available.

10. The method of claim 9, wherein the update to the supplier dashboard comprises inventory parameters, subscription types, security related information, version of the supplier dashboard.

11. The method of claim 1, wherein the customer related analytics comprises customer behaviour tracking with respect to the product displayed at the kiosk.

12. The method of claim 1, wherein managing product inventory and product related information displayed at the kiosk comprising updating product specification, updating brand specific information, customising user interface elements displayed at the customer console, updating existing offers on the product being displayed to the customer.

13. The method of claim 1, wherein the kiosk comprising
a product display platform for displaying the product;
a display panel for displaying the product related information;
the customer console for presenting the customer dashboard that enables the customer to navigate through the product specifications, and place purchase order; and
the one or more sensor means for capturing the second set of data.

14. A system for facilitating marketing and sales of a product by a product supplier, the system comprising:
a kiosk adapted for displaying the product, wherein the kiosk is accessible by the product supplier upon subscribing for a kiosk service from a server relate to a kiosk service provider, the kiosk comprising:
a product display platform for displaying the product;
a display panel for displaying product related information;
a customer console for presenting a customer dashboard that enables a customer to navigate through product specifications, and place purchase order, wherein the customer dashboard is adapted for capturing a first set of data at the kiosk; and
one or more sensor means for capturing a second set of data;
a supplier dashboard configured to receive the first set of data and the second set of data for performing product inventory, and customer related analytics, the supplier dashboard is accessible and manageable by the product supplier subscribed to the server; and
one or more data store configured to store the first set of data, the second set of data, and data related to the product inventory, and customer related analytics.

15. The system of claim 14, wherein the server is configured to send a notification to one of the customer if any changes to the purchase order of the customer occurs, and the product supplier if any update to the supplier dashboard is available.

16. The system of claim 14, wherein the product supplier manages product inventory and product related information displayed at the kiosk, based on the performed product inventory and customer related analytics.

17. The system of claim 14, wherein the first set of data comprises customer information, brand information, purchase order information, ratings provided on product, and feedback provided on product.

18. The system of claim 14, wherein the second set of data comprises live video stream of customers, live video steam of surroundings, recorded historical videos of the customers, recorded historical videos of surrounding, and customer gesture information captured by the one or more sensor means.

19. The system of claim 14, wherein the one or more sensor means comprises at least one of: one or more cameras, at least a motion sensor, a gesture sensor, a proximity sensor.
